(19) United States
(12) Patent Application Publication
(10) Pub. No.: US 2013/0276995 A1
(43) Pub. Date: Oct. 24, 2013

(54) COUNTERBALANCED ROLL TYPE BLIND OR SHADE SYSTEM HAVING A CONFIGURATION TO UTILIZE AN EXTERNAL POWER SUPPLY OR AN EXTERNAL MOTOR CONTROLLER

(71) Applicants: Willis Jay MULLET, Gulf Breeze, FL (US); Darrin W. BRUNK, Pensacola, FL (US); Richard Scott HAND, Pace, FL (US); William Ashton Lee Cutts LUCAS, McDavid, FL (US)

(72) Inventors: Willis Jay MULLET, Gulf Breeze, FL (US); Darrin W. BRUNK, Pensacola, FL (US); Richard Scott HAND, Pace, FL (US); William Ashton Lee Cutts LUCAS, McDavid, FL (US)

(73) Assignee: HOMERUN HOLDINGS CORPORATION, Pensacola, FL (US)

(21) Appl. No.: 13/449,800

(22) Filed: Apr. 18, 2012

(51) Int. Cl. E06B 9/70; E06B 9/62

(52) U.S. Cl. 160/310

(57) ABSTRACT

A motorized roller shade includes a roller shade tube including an outer surface, an inner surface defining an inner cavity, and at least one end portion, a shade attached to the outer surface of the roller shade tube, and a counterbalancing unit configured to provide a counterbalancing force to the roller shade. The motorized shade further includes a motor configured to provide rotational exertion to the roller shade, a controller configured to provide control signals to the motor, a power supply configured to provide power at least to one of the motor and the controller, and a transfer device configured to transfer one of the control signals to the motor that is configured to rotate and power to the controller that is configured to rotate from a stationary external source.

### FIELD OF THE INVENTION

The invention relates to a roll shade that is configured to have an external power supply and/or external motor controller. Specifically, the invention relates to a roll shade that is structured and configured to include arrangements for an external power supply and/or external motor controller to connect to internal roll shade components.

### BACKGROUND OF THE INVENTION

A roll shade is a rectangular panel of fabric, or other material, that is attached to a cylindrical, rotating tube. The shade tube is typically mounted near a header of a window or door such that the shade rolls up upon itself as the shade tube rotates in one direction, and rolls down to cover a desired portion of the window or door when the shade tube is rotated in the opposite direction.

A motor may typically be located inside the shade tube, may be fixed to the roller shade support and/or may be connected to a simple switch. In more sophisticated applications, a radio frequency (RF) based system controls the activation of the motor and the rotation of the shade tube. The roll shade typically may include a counter-balance mechanism, such as counter-balance springs, that counter-balance the weight of the shade. The roll shade requires a power source and a controller for operation of the motor. Typically the power source and controller are mounted internally to the roll shade. However, internal mounting of the power source and/or controller makes manufacturing more complex and expensive, makes servicing and battery replacement more complex and time consuming, and/or may not be possible in some applications where there is not sufficient internal space within the shade.

Accordingly, there is a need for a motorized roll shade that can be configured to be have an external power source and/or motor controller to one or more of reduce manufacturing complexity and cost, make servicing and battery replacement faster and easier, and address applications where internal space is limited.

### SUMMARY OF THE INVENTION

Aspects of the invention advantageously provide a motorized roller shade that includes a roller shade tube including an outer surface, an inner surface defining an inner cavity, and at least one end portion, a shade attached to the outer surface of the roller shade tube, a counterbalancing unit configured to provide a counterbalancing force to the roller shade, a motor configured to provide rotational exertion to the roller shade, a controller configured to provide control signals to the motor, a power supply configured to provide power at least to one of the motor and the controller, and a transfer device configured to transfer one of the control signals to the motor that is configured to rotate and power to the controller that is configured to rotate from a stationary external source.

The power supply may be arranged outside the roller shade tube and the power supply transfers power through the transfer device. The external source may include the controller which is arranged outside the roller shade tube and the controller transfers control signals through the transfer device. The end portion may include a support shaft and an external input extends through the shaft to the transfer device. The end portion may include a support shaft and an external input extends through the shaft and through the counterbalancing unit to the transfer device, wherein the input inputs one of control signals and power. The end portion may include a support shaft and an external input extends through a hollow portion of the shaft and the counterbalancing unit to the transfer device, wherein the input inputs one of control signals and power. The end portion may include a support shaft and an external input extends through a hollow portion of the shaft, and the counterbalancing unit comprises a hollow shaft and the external input extends through the hollow shaft of the counterbalancing unit to the transfer device, wherein the input inputs one of control signals and power. The motorized roller shade may include an external input configured to be stationary and extend to the transfer device, and leads configured to rotate and extend from the transfer device to one of the motor and the controller, where the input inputs one of control signals and power. The transfer device may include a slip ring. The counterbalancing unit may include at least one spring.

Other aspects of the invention advantageously provide a motorized roller shade that includes a roller shade tube including an outer surface, an inner surface defining an inner cavity, and at least one end portion, a shade attached to the outer surface of the roller shade tube, a counterbalancing unit configured to provide a counterbalancing force to the roller shade, a motor configured to provide rotational exertion to the roller shade, a controller configured to provide control signals to the motor, a power supply configured to provide power at least to one of the motor and the controller, and a transfer device configured to transfer from a stationary external source one of power and signals to one the motor and the controller that are configured to rotate from.

The external source may include the power supply which is arranged outside the roller shade tube and the power supply transfers power through the transfer device. The external source may include the controller which is arranged outside the roller shade tube and the controller transfers control signals through the transfer device. The end portion may include a support shaft and an external input extends through the shaft to the transfer device. The end portion may include a support shaft and an external input extends through the shaft and through the counterbalancing unit to the transfer device, wherein the input inputs one of control signals and power. The end portion may include a support shaft and an external input extends through a hollow portion of the shaft and the counterbalancing unit to the transfer device, wherein the input inputs one of control signals and power. The end portion may include a support shaft and an external input extends through a hollow portion of the shaft, and the counterbalancing unit comprises a hollow shaft and the external input extends through the hollow shaft of the counterbalancing unit to the transfer device, wherein the input inputs one of control signals and power. The motorized roller may include an external input configured to be stationary and extend to the transfer device, and leads configured to rotate and extend from the transfer device to one of the motor and the controller, wherein the input inputs one of control signals and power. The transfer device may include a slip ring. The counterbalancing unit may include at least one spring.

Generally, the invention relates to a counterbalanced roll type window or door covering system where the coverings are designed to extend to the ends of the roll tube and be deployed from and stored on the roll tube. The roll tube contains a drive motor and a counterbalance system that completely fits within the roll tube and the output shaft of the counterbalance system may be configured, such as being hollow, to allow a path for wiring from a power supply external to the roll tube to pass to the motor and motor controls. This path can also be for control wires from a motor controller mounted external to the roll tube. Rotation of the roller shade is accomplished with the motor that is coupled to the shade tube.

There has thus been outlined, rather broadly, certain aspects of the invention in order that the detailed description thereof herein may be better understood, and in order that the present contribution to the art may be better appreciated. There are, of course, additional aspects of the invention that will be described below and which will form the subject matter of the claims appended hereto.

In this respect, before explaining at least one aspect of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1 is a perspective view of an aspect of a roll shade assembly constructed in accordance with aspects of the invention.

FIG. 2 is a perspective view of FIG. 1 showing the roll shade separated from the storage roll assembly and the mounting brackets.

FIG. 3 is a perspective view of the storage roll with the counterbalance spring and the motor and control assemblies removed.

FIG. 4 is an exploded perspective view of the storage roll internal components.

FIG. 5 is an exploded perspective view of the counterbalance spring assembly of a first aspect constructed in accordance with aspects of the invention.

FIG. 6 is an exploded perspective view of the first aspect having an in-the-tube motorized control assembly.

FIG. 7 is a section view of the first aspect and further showing the location of the section shown in FIG. 8.

FIG. 8 is an enlarged section view from FIG. 7 showing the counterbalance spring system.

FIG. 9 is a section view of a second aspect showing the location of the section shown in FIG. 10.

FIG. 9a is a perspective view of FIG. 9 showing the motor assembly.

FIG. 10 is an enlarged section view taken from FIG. 9.

FIG. 11 is an exploded perspective view of the motor end of the second aspect.

FIG. 12 is an exploded perspective view from the opposite direction from FIG. 11.

### DETAILED DESCRIPTION

The invention will now be described with reference to the drawing Figures, in which like reference numerals refer to like parts throughout. The term “shade” as used herein describes any flexible material, such as a shade, a curtain, a screen, etc., that can be deployed from, and retrieved onto, a storage tube or similar structure.

Generally, the invention relates to a roll type window or door covering system where the coverings are designed to be deployed and stored as part of a roll shade system having a counterbalanced suspension system.

There are a number of different approaches to motorized window or door coverings where the coverings, such as a blind or shade, have one or more of an actuator within a housing that holds a motor and a counterbalance system. The roll shade may further include at least one of a control signal receiver and generator and a battery. A rotor of the motor is typically coupled to at least one shaft for raising and lowering the blind or shade to control the amount of solar gain or privacy. In some applications, a control signal generator may generate a control signal for completing the electrical circuit between the battery and the motor. The control signal may be generated in response to a predetermined amount of daylight or in response to a user-generated remote command signal. The actuator can be used to open or close the shade or blind.

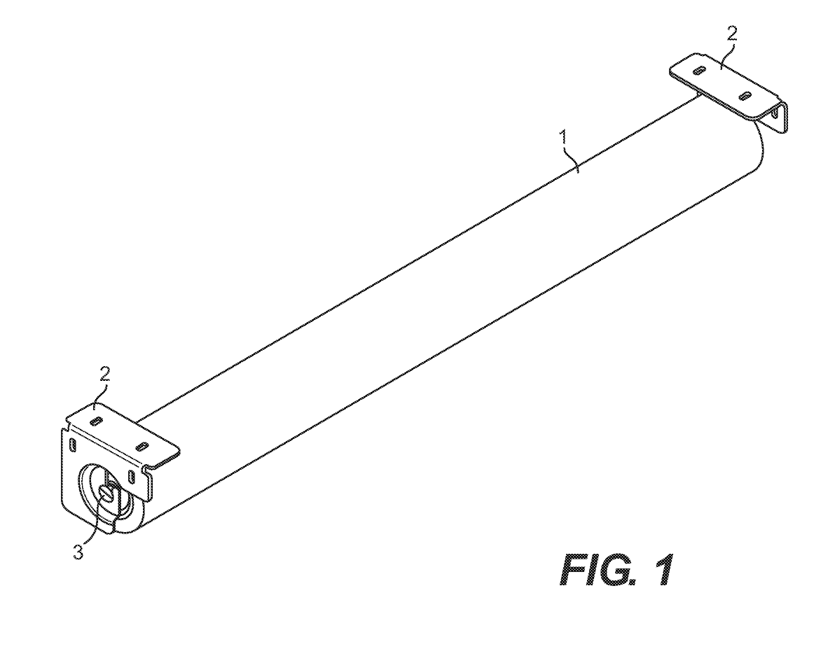

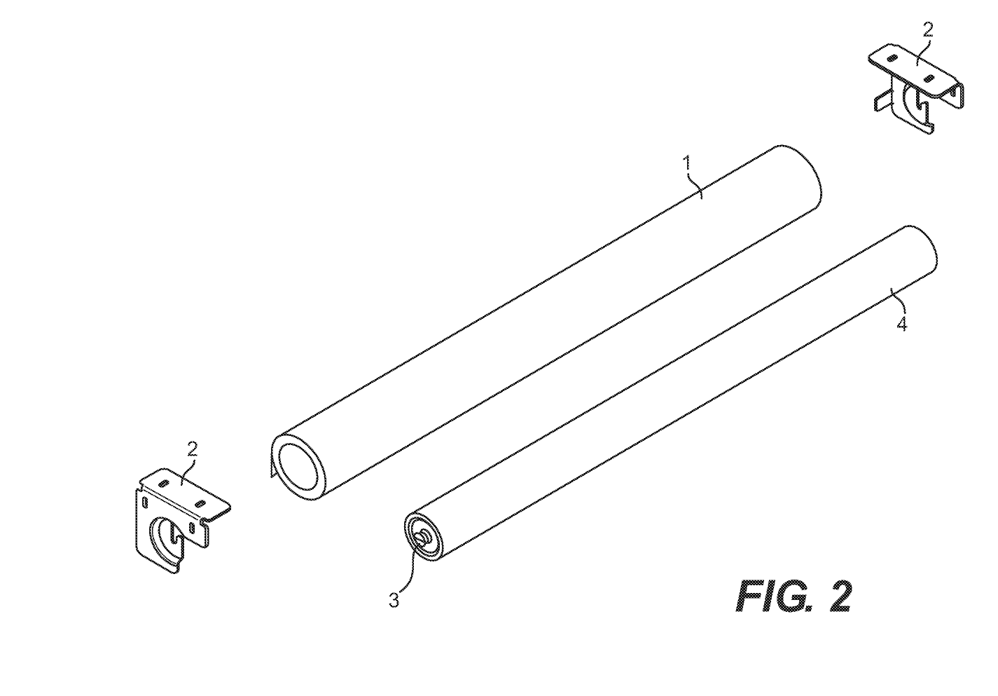

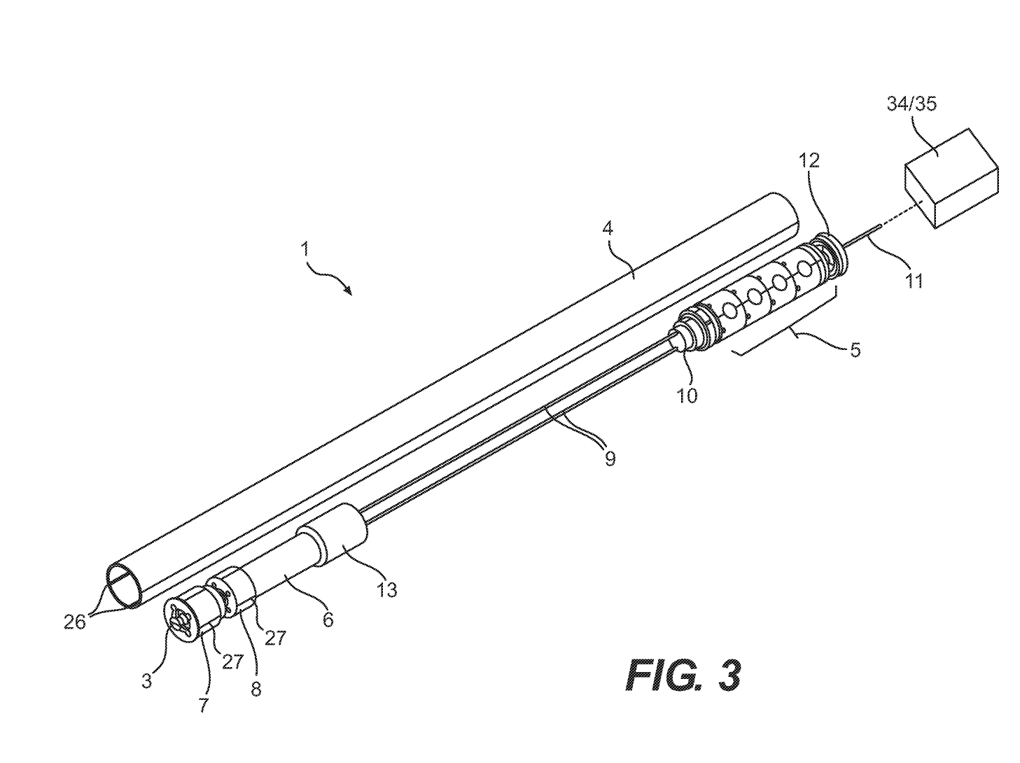

FIG. 1 is a perspective view of an aspect of a roll shade assembly constructed in accordance with aspects of the invention; FIG. 2 is a perspective view of FIG. 1 showing the roll shade separated from the storage roll assembly and the mounting brackets; and FIG. 3 is a perspective view of the storage roll with the counterbalance spring and the motor and control assemblies removed. In particular, FIGS. 1-3 show a roll assembly 1 with shafts 3, 16 (not shown) that may be held by end brackets 2. The roll assembly 1 may include a shade roll tube 4 as shown in FIG. 2. As further shown in FIG. 3, the roll assembly 1 may include a motor 6, a control system 13, and a counterbalance system 5. In some aspects, the control system 13 may also be externally mounted.

The roll assembly 1 may include a mechanical configuration to hold various components. As shown in FIG. 3, the roll tube 4 may have at least one groove 26 extending along an inner surface of the tube 4. One or more protrusions 27 on various components such as a bearing housing 7, the counterbalance system 5, a drive spindle 8, the control system 13, and the like may be configured so that the at least one protrusion 27 may mate and fit in the groove 26 of the roll tube 4 to prevent rotational movement between components. Although a groove 26 and protrusion 27 arrangement is shown, other mechanical configurations to hold various components are contemplated by the invention.

The roll assembly 1 may also include a mechanical configuration to prevent the shafts from rotating with respect to end brackets 2. In particular, the output shaft 3 from the motor 6 may have a configuration that mates with the slot in the end bracket 2 and prevents turning of the shaft 3 so that the motor 6 rotates along with the roll tube 4 and control system 13. Further there may be a similar arrangement for the shaft 16 (not shown) so that the counterbalance spring assembly 5 will rotate instead of the shaft 16.

The bearing housing 7 may assist in maintaining the shaft 3 concentrically within the roll tube 4. More specifically, the bearing housing 7 partially contains the shaft 3 which may be connected to the motor 6. The motor 6 may be electrically connected to the controller 13. The controller 13 may be electrically connected to lead wires 9 that extend towards the counterbalance springs 5.

The invention includes structure to allow the motor 6 and/or controller 13 to be connected to an external power supply 34 and/or to allow the motor 6 to be connected to an external controller 35. This arrangement of the invention particularly includes the ability for the controller 13 and motor 6 to receive external power from the power supply 34, whether from a battery or other type of power supply that is arranged externally; or includes a configuration to allow controller signals from an externally arranged controller 35 to be input to the roll shade 1 and the motor 6. In particular, this arrangement may provide the ability to deliver power and/or signals through input 11 from a non-rotating source to a rotating arrangement such as the controller 13 and motor 6.

In one particular configuration shown in FIG. 3, the input wires 11 extend through the counterbalance springs 5 and connect to a slip ring 10. The slip ring 10 allows for rotational movement of the counterbalance springs 5 and/or the motor 6 and controller 13 without twisting or damaging components including the lead wires 9 and input wires 11 and further allows transfer of signals and or power between the external components and internal components. The input wires 11 may extend from the slip ring 10 through the counterbalance springs 5 and bearing housing 12 so as to extend through shaft 16 to connect to the external power supply 34 and/or the external controller 35.

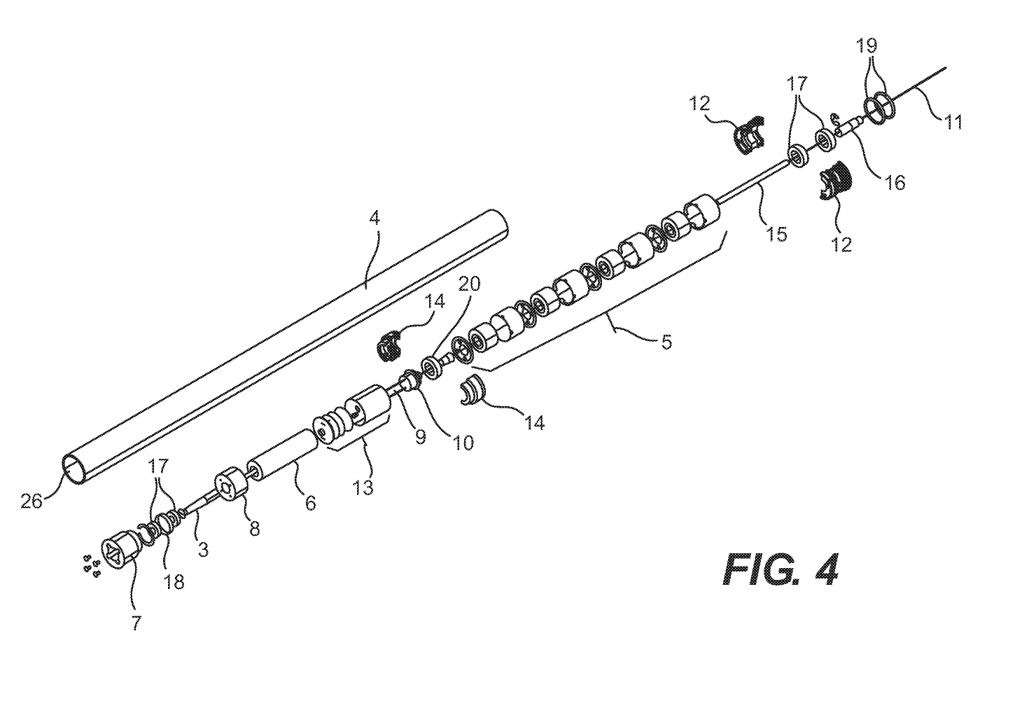

FIG. 4 is an exploded perspective view of the storage roll internal components. Further shown in FIG. 4 are the details of one particular implementation. More specifically, bearing housing 7 may house the shaft 3 extending therethrough and may include bearings 17 and a spacer 18. Adjacent to the bearing housing 7 may be a drive spindle 8. The shaft 3 may extend through both the bearing housing 7 and the drive spindle 8 to connect to the motor 6. The motor 6 may be electrically connected to the controller 13. The controller 13 may receive power from the leads 9 and the power may be provided through the slip ring 10 which may allow for a connection to the stationary input wires 11 and allow a rotation of the leads 9. The slip ring 10 may further include a slip ring housing 14 together with a support bearing 20. As further shown in FIG. 4, the counterbalance springs 5 may include a spring shaft 15 and bearings 17 that may be held in a bearing housing 12 and may include O-rings 19. As shown in FIG. 4, the input wires 11 may extend through the O-rings 19, spring shaft 16, bearings 17, spring shaft 15, and through the counterbalance springs 5, to connect to the slip ring 10. Although a particular arrangement of connection is shown, any connection capable of allow rotation between the input wires 11 and controller 13 is within the scope and spirit of the invention. Additionally, as noted above the controller 13 may also be arranged externally to the roll shade 1. In such an arrangement, a similar slip ring 10 configuration or the like may be used.

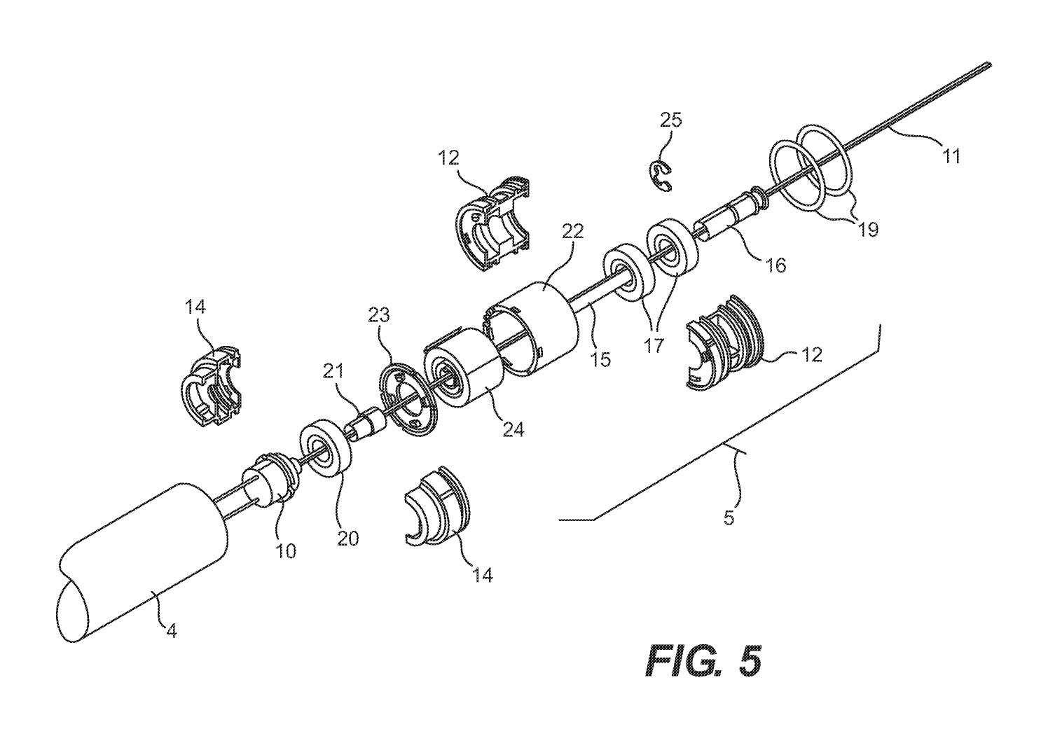

FIG. 5 is an exploded perspective view of the counterbalance spring assembly of a first aspect constructed in accordance with aspects of the invention. The FIG. 5 aspect shows an arrangement with a lower counterbalance requirement where only one counterbalance spring 5 is needed and an additional support bearing 20 may be added to prevent parasitic drag in the roll tube 4. In particular, FIG. 5 shows the support bearing 20 along with an adaptation 21 held within a slip ring housing 14 and adjacent a spring 24. A spring cover 23 is also shown adjacent to the spring 24. Further shown in FIG. 5 is a bearing housing 12 to house the bearings 17 arranged adjacent the spring housing 22. There is additionally shown an e-clip 25 that may maintain shaft 16 in a lateral position.

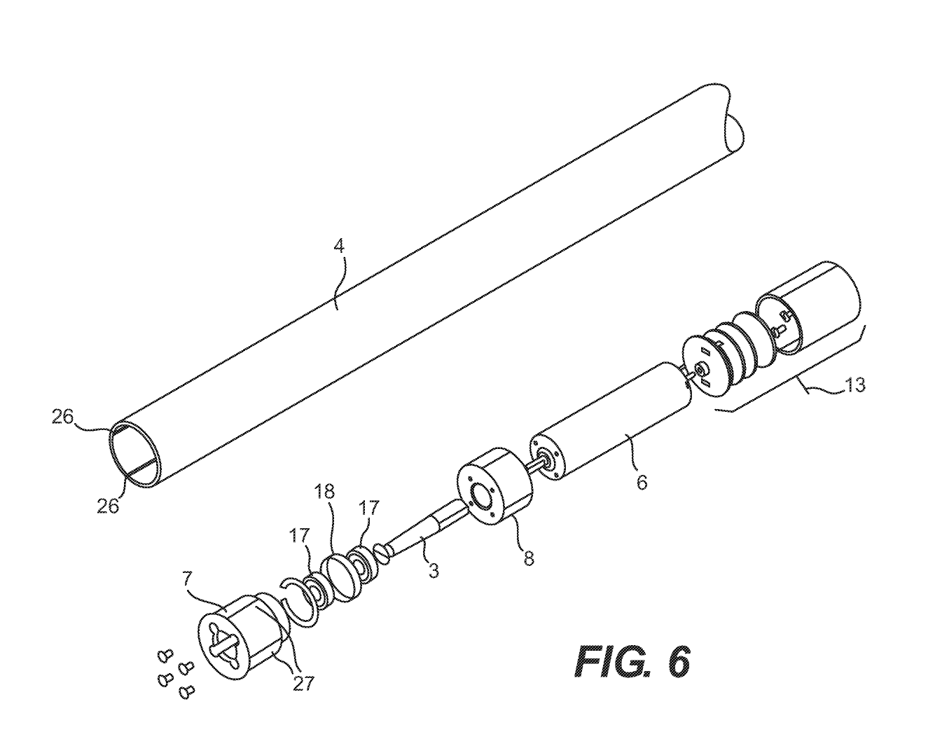

FIG. 6 is an exploded perspective view of the first aspect having an in-the-tube motorized control assembly. In particular, FIG. 6 shows further details of the bearings 17 and the spacer 18. Again note that the controller 13 is arranged within the roll shade 1 and adjacent the motor 6. It is just as likely that the controller may be arranged externally to the roll shade 1 as an external controller 35.

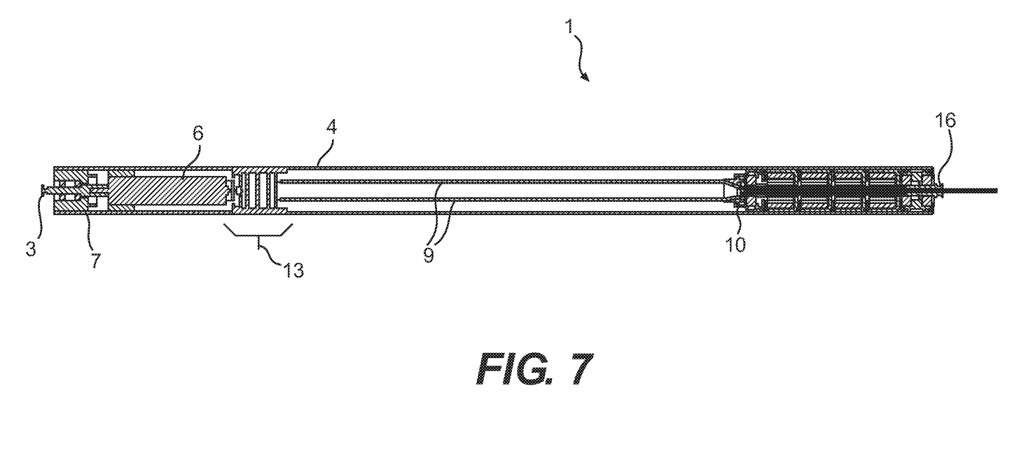

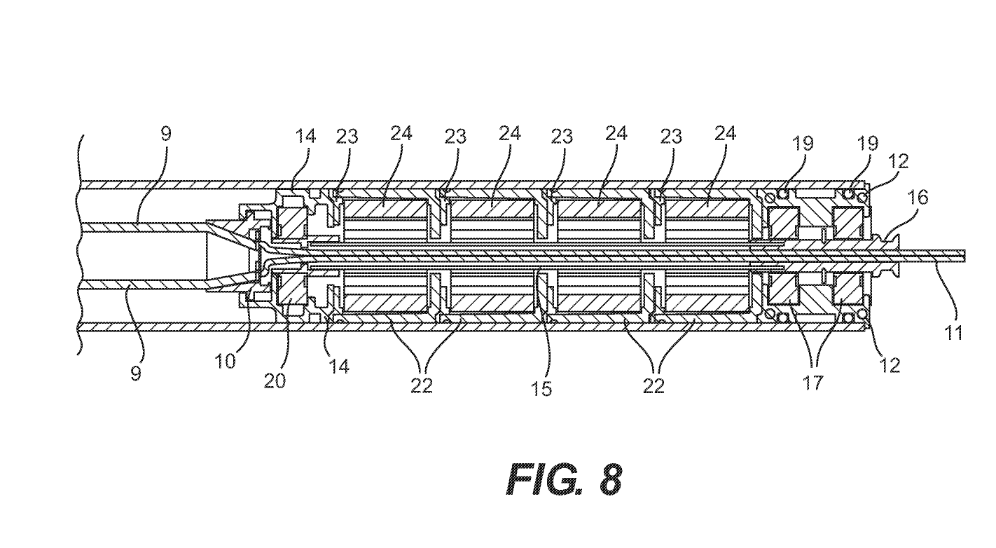

FIG. 7 is a section view of the first aspect and further shows the location of the section shown in FIG. 8. More specifically, FIGS. 7 and 8 are aspects for a larger shade requiring additional spring packages (22, 23, 24) to achieve proper counterbalancing. In particular, FIGS. 7 and 8 have four spring packages (22, 23, 24). Of course, any number of spring packages (22, 23, 24) are contemplated based on the application.

FIG. 7 also shows the details of connection between motor 6 and controller 13 within the roll shade 1. FIG. 7 shows the connection between the shaft 3 as it is arranged in the housing 7 and the motor 6. Further, FIG. 7 shows the connection between controller 13 and lead wires 9 and the roll housing 4, together with the connection between lead wires 9 and the slip ring 10 and the subsequent connection to input wires 11 that extend from the end. Note that the lead wires 9 from split ring 20 traverse and turn with the roll tube 4. The input wires 11 are stationary as are the mounting shaft 16 and the spring shaft 15.

FIG. 8 is an enlarged section view from FIG. 7 showing the counterbalance spring system. FIG. 8 shows the lead wires 9 extending into the slip ring 10 and making contact with input 11. The input 11 may be arranged within the support bearing 20 and slip ring housing 14. The input 11 may extend through the plural spring covers 23, springs 24, and spring housings 22. The input 11 further extends through bearings 17, O-rings 19, bearing housing springs 12 and through shaft 16 to extend out the end of the roll shade 1 in order to connect to an external power supply 34 or external controller 35.

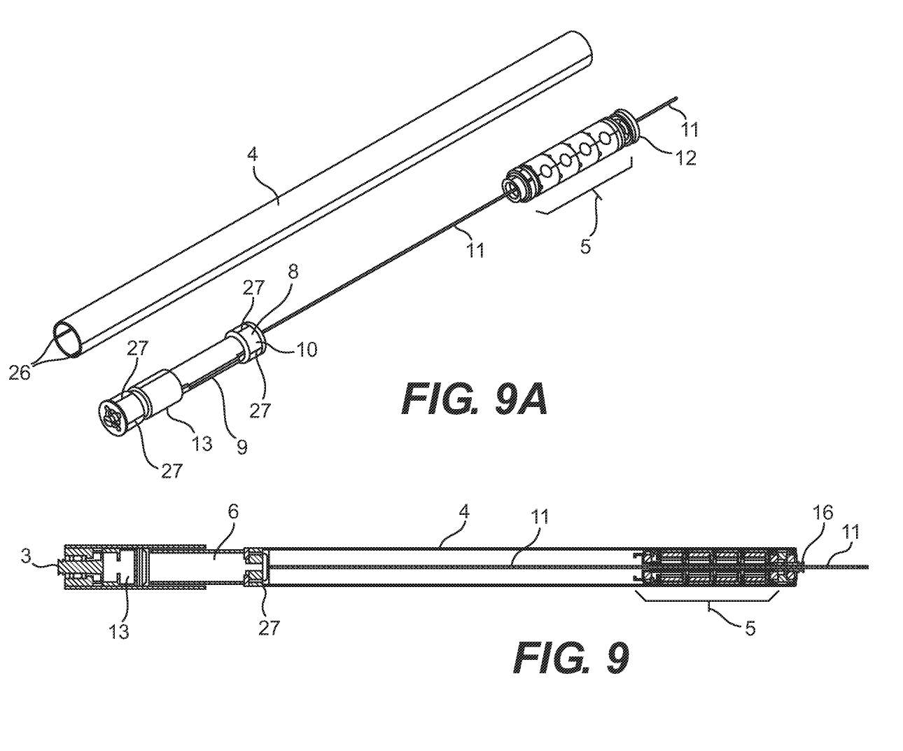

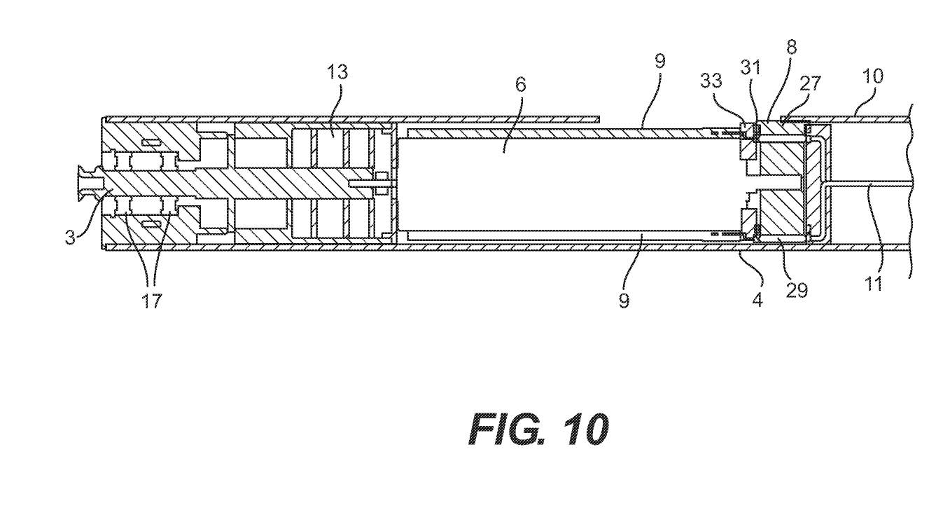

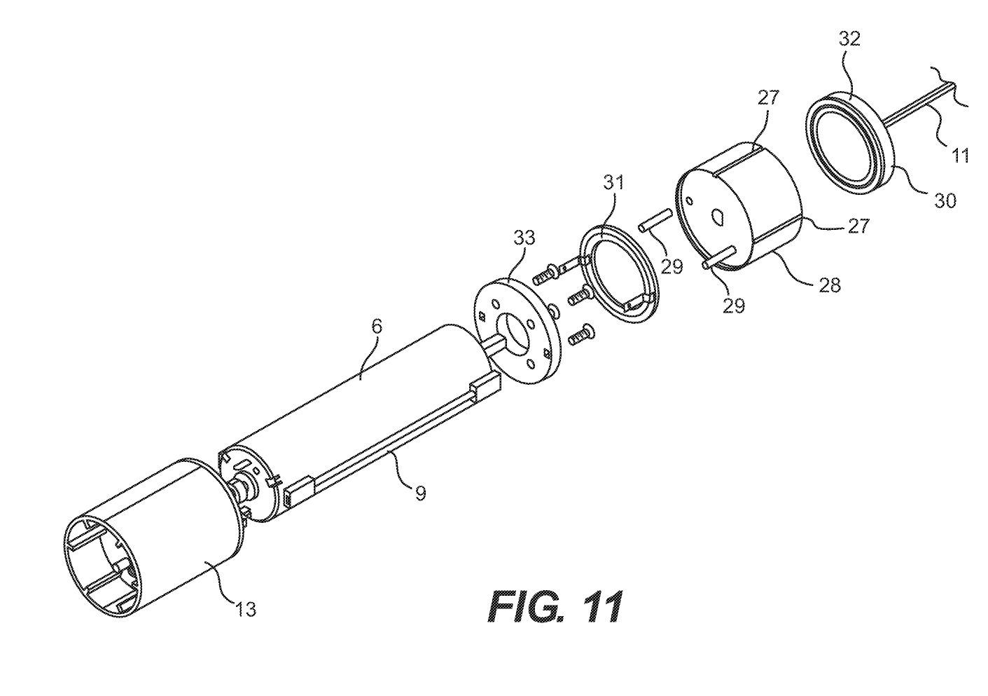

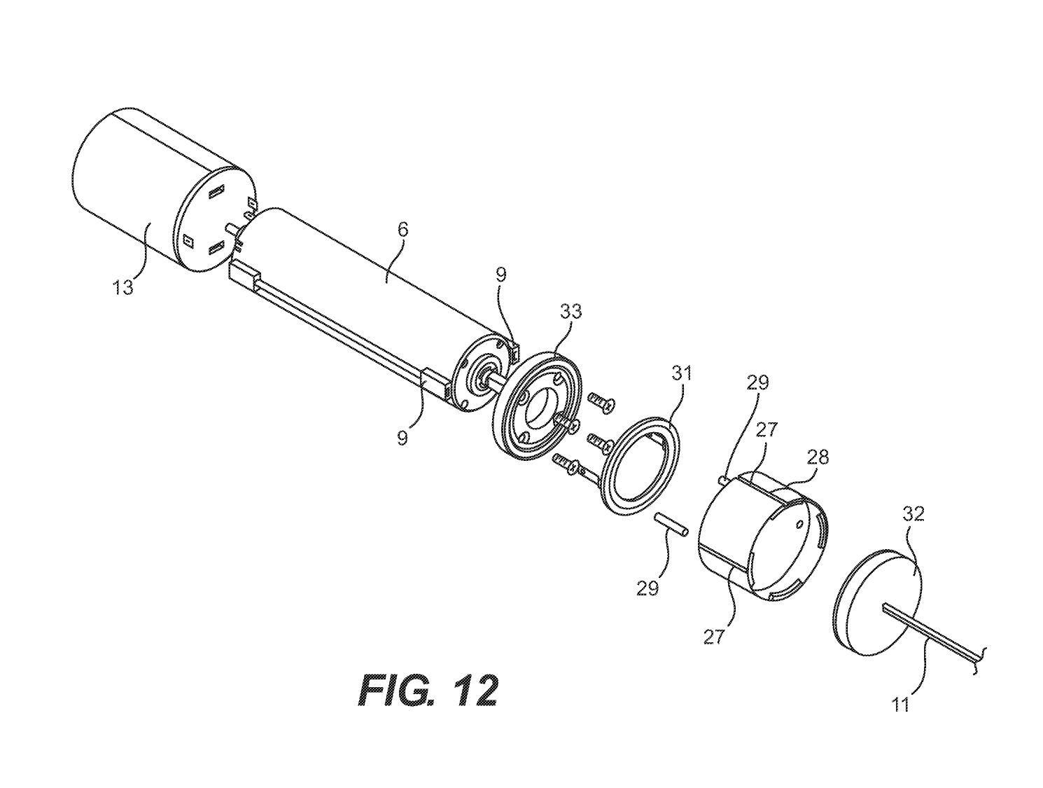

FIG. 9 is a section view of a second aspect showing the location of the section shown in FIG. 10; FIG. 9a is a perspective view of FIG. 9 showing the motor assembly; FIG. 10 is an enlarged section view taken from FIG. 9; FIG. 11 is an exploded perspective view of the motor end of the second aspect; and FIG. 12 is an exploded perspective view from the opposite direction from FIG. 11.

FIGS. 9-12 cover a second aspect of the invention. This arrangement configures the drive from the motor 6 to pass through the drive spindle 8 while also providing the slip ring 10 functions. In this case, the counterbalance spring 5 may be separate from the slip ring 10. The slip ring 10 provides the function of the drive spindle 8 and has protrusions 27 to facilitate driving the roll tube 4. The input wires 11 do not rotate with the roll tube 4 and neither do the lead wires 9 from the slip ring 10 to the controller 13. The controller 13 may be arranged to an outboard side of the motor 6 and the power may be fed through the leads 9 from the slip ring 10. The motor support shaft 3 passes through the controller 13 preventing the motor 6 from turning allowing the drive spindle 8 to turn the roll tube 4.

FIG. 9 and FIG. 9a shows the shaft 3 extending through the controller 13. The lead wires 9 arranged between controller 13 and motor 6 extend along the outside of motor 6. Arranged next to the motor 6 is the drive spindle 8. The drive spindle 8 may connect the input wires 11 to the motor 6. The input wires 11 may extend through the counterbalance springs 5 to an external position outside the housing. The arrangement shown in FIGS. 9 and FIG. 9 includes a configuration to allow input 11 to not rotate and the motor 6 and controller 13 to rotate without damage to any of the components.

FIG. 10 shows the shaft 3 arranged within bearings 17 and extending to motor 6 and being connected thereto. The shaft 3 further includes a configuration to extend through controller 13. As further shown in FIG. 10, the lead wires 9 may extend along motor 6 and connect to a lead ring cover 33 which includes lead rings 31 and input rings 30. The drive spindle 8 may be used to guide input 11 and hold the contacts 29 such that the contacts 29 contact lead rings 31 to transmit power and or signals from stationary input 11 to rotating leads 9.

Although the above is a specific implementation of an arrangement for an external power supply and/or external motor controller to connect to internal roll shade components, it is within the scope and spirit to have other implementations.

Accordingly, the shade of the invention as described above in the various exemplary aspects associated with the drawings and broader applications described above can utilize an external power source and/or motor controller to one or more of reduce manufacturing complexity and cost, make servicing and battery replacement faster and easier, and address applications where internal space is limited.

The motorized roller shade assembly may include other components such as an electrical power connector that includes a terminal that couples to a power supply unit, and power cables that may connect to the circuit board(s) located within the circuit board housing.

In some aspects, two circuit boards may be mounted within the circuit board housing in an orthogonal relationship. Circuit boards generally include all of the supporting circuitry and electronic components necessary to sense and control the operation of the motor, manage and/or condition the power provided by the power supply unit, etc., including, for example, a controller or microcontroller, memory, a wireless receiver, etc. In one aspect, the microcontroller is a Microchip 8-bit microcontroller, such as the PIC18F25K20, while the wireless receiver is a Micrel QwikRadio® receiver, such as the MICRF219. The microcontroller may be coupled to the wireless receiver using a local processor bus, a serial bus, a serial peripheral interface, etc. In another aspect, the wireless receiver and microcontroller may be integrated into a single chip, such as, for example, the Zensys ZW0201 Z-Wave Single Chip, etc. In another aspect, a wireless transmitter is also provided, and information relating to the status, performance, etc., of the motorized roller shade may be transmitted periodically to a wireless diagnostic device, or, preferably, in response to a specific query from the wireless diagnostic device.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A motorized roller shade comprising:
a roller shade tube including an outer surface, an inner surface defining an inner cavity, and at least one end portion;
a shade attached to the outer surface of the roller shade tube;
a counterbalancing unit configured to provide a counterbalancing force to the roller shade;
a motor configured to provide rotational exertion to the roller shade;
a controller configured to provide control signals to the motor;
a power supply configured to provide power at least to one of the motor and the controller; and
a transfer device configured to transfer from a stationary external source at least one of the control signals to the motor that is configured to rotate, and power to the controller that is configured to rotate.

2. The motorized roller shade according to claim 1 wherein
the external source comprises the power supply and the controller arranged outside the roller shade tube,
the controller transfers the control signals through the transfer device, and
the power supply transfers power through the transfer device.

3. (canceled)

4. The motorized roller shade according to claim 1 wherein the at least one end portion comprises a support shaft and an external input extending through the shaft to the transfer device.

5. The motorized roller shade according to claim 1 wherein the at least one end portion comprises a support shaft and an external input extending through the shaft and through the counterbalancing unit to the transfer device, wherein the input inputs one of the control signals and power.

6. The motorized roller shade according to claim 1 wherein the at least one end portion comprises a support shaft and an external input extending through a hollow portion of the shaft and the counterbalancing unit to the transfer device, wherein the input inputs one of the control signals and power.

7. The motorized roller shade according to claim 1 wherein the at least one end portion comprises a support shaft and an external input extending through a hollow portion of the shaft; and the counterbalancing unit comprises a hollow shaft and the external input extending through the hollow shaft of the counterbalancing unit to the transfer device, wherein the input inputs one of the control signals and power.

8. The motorized roller shade according to claim 1 further comprising:
an external input configured to be stationary and extend to the transfer device; and
leads configured to rotate and extend from the transfer device to one of the motor and the controller, wherein the input inputs one of the control signals and power.

9. The motorized roller shade according to claim 1 wherein the transfer device comprises a slip ring.

10. (canceled)

11. A window or door covering system comprising:
a housing including an outer surface, an inner surface defining an inner cavity, and at least one end portion;
a covering attached to the outer surface of the housing;
a counterbalancing unit located in said cavity and configured to provide a counterbalancing force to the covering;
a motor located in said cavity and configured to provide rotational exertion to the covering;
an external source arranged outside of said housing including a controller configured to provide control signals to the motor and a power supply configured to provide power at least to one of the motor and the controller; and
a transfer device configured to transfer the control signals and power from the external source to the motor.

12-13. (canceled)

14. The window or door covering system according to claim 11 wherein the at least one end portion comprises a support shaft and an external input extending through the shaft to the transfer device.

15. The window or door covering system according to claim 11 wherein the at least one end portion comprises a support shaft and an external input extending through the shaft and through the counterbalancing unit to the transfer device, wherein the input inputs one of the control signals and power.

16. The window or door covering system according to claim 11 wherein the at least one end portion comprises a support shaft and an external input extending through a hollow portion of the shaft and the counterbalancing unit to the transfer device, wherein the input inputs one of the control signals and power.

17. The window or door covering system according to claim 11 wherein the at least one end portion comprises a support shaft and an external input extending through a hollow portion of the shaft; and the counterbalancing unit comprises a hollow shaft and the external input extends extending through the hollow shaft of the counterbalancing unit to the transfer device, wherein the input inputs one of the control signals and power.

18. The window or door covering system according to claim 11 further comprising:
an external input configured to be stationary and extend to the transfer device; and
leads configured to rotate and extend from the transfer device to one of the motor and the controller, wherein the input inputs one of the control signals and power.

19. The window or door covering system according to claim 11 wherein the transfer device comprises a slip ring.

20. (canceled)
